(19) United States
(12) Patent Application Publication
(10) Pub. No.: US 2003/0148914 A1
(43) Pub. Date: Aug. 7, 2003

(54) Detergent system

(75) Inventors: Bruno Matthieu Dasque, Brussels (BE); Liben Hailu, Cincinnati, OH (US); Nigel Somerville-Roberts, Newcastle upon Tyne (GB); Jose Luis Vega, Strombeek-Bever (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/279,247

(22) Filed: Oct. 24, 2002

Related U.S. Application Data
(60) Provisional application No. 60/345,862, filed on Oct. 29, 2001.

(51) Int. Cl. C11D 17/00

(52) U.S. Cl. 510/447; 510/296; 510/444

(57) ABSTRACT

The present invention relates to a detergent system comprising at least one solid detergent composition in the form of a tablet and at least one liquid or gel filled water-soluble pouch composition packaged together in a water-insoluble film wrap.

The system of the present invention allow for maximum detergent efficacy and formulation flexibility while minimising the material and/or equipment costs associated with such a system.

The present invention also relates to a method of cleaning in an automatic washing machine said method comprising adding at least one solid detergent composition in the form of a tablet and at least one liquid or gel filled water-soluble pouch composition to the machine and then cleansing in the normal manner.

### CROSS REFERENCE TO RELATED APPLICATIONS

This application claims priority under 35 U.S.C. §119(e) to U.S. Provisional Application Serial No. 60/345,862, filed Oct. 29, 2001 (Attorney Docket No. CM2620FP).

### FIELD OF THE INVENTION

The present invention relates to a detergent system comprising at least one solid detergent composition in the form of a tablet and at least one liquid or gel filled water-soluble pouch composition packaged together in a water-insoluble film wrap.

### BACKGROUND TO THE INVENTION

Laundry detergent products can be found on the market to date in various forms, such as solid granular compositions and tablets, or liquid compositions. This gives the consumer a choice of detergent products they can use.

Some detergent ingredients currently used by the laundry industry, are preferably manufactured and processed in solid form, for example because these ingredients are water-insoluble and are difficult or costly to include in a liquid detergent composition, or because these materials are preferably transported and supplied in solid form and therefore require extra processing steps to enable them to be included in a liquid detergent composition. Such detergent ingredients include water insoluble builders such as zeolites which can be included in liquid detergent compositions but only in limited amounts typically less than 20%. Also, certain ingredients are formed into granular form and supplied and processed in solid form for stability reasons, for example certain enzyme prills.

Conversely, some detergent ingredients currently used by the laundry industry, are preferably manufactured and processed in liquid form. These liquid ingredients are difficult or costly to include in a solid detergent composition. Also, certain ingredients are preferably transported and supplied to detergent manufacturers in a liquid form and require additional, and sometimes costly, process steps to enable them to be included in a solid detergent composition. An example of these detergent ingredients are surfactants, especially nonionic surfactants which are typically liquid at room temperature or are typically transported and supplied to detergent manufacturers in liquid form. Another example of liquid detergent ingredients is cationic fabric softeners.

Therefore, to minimize the cost of a formulation it is desirable to have a detergent system comprising both solid and liquid components. In addition, having both solid and liquid components allows for maximum efficiency of the detergent system since certain ingredients are more efficient when delivered as solids (e.g. insoluble or soluble builders) and certain ingredients preferably delivered as a liquid (e.g. surfactants as you can deliver much higher levels).

GB Patent Application 0010249.1 (Procter & Gamble) and GB Patent Application 0010227.7 (Procter & Gamble) offer one way of delivering a detergent system having both solid and liquid components. This is achieved by means of multi-compartment pouches wherein one compartment comprise solid and the other compartment comprises liquid. While this system works very well technically it does have the disadvantage that specialised equipment is required to produce multi-compartment pouches. Therefore, it would be desirable to produce a detergent system comprising both solid and liquid components using existing production means.

### SUMMARY OF THE INVENTION

The present invention relates to a detergent system comprising at least one solid detergent composition in the form of a tablet and at least one liquid or gel filled water-soluble pouch composition packaged together in a water-insoluble film wrap.

The system of the present invention allow for maximum detergent efficacy and formulation flexibility while minimising the material and/or equipment costs associated with such a system.

The present invention also relates to a method of cleaning in an automatic washing machine said method comprising adding at least one solid detergent composition in the form of a tablet and at least one liquid or gel filled water-soluble pouch composition to the machine and then cleansing in the normal manner.

### DETAILED DESCRIPTION OF THE INVENTION

The system of the present invention involves three essential components, a solid detergent composition in the form of a tablet, a liquid or gel filled water-soluble pouch composition, and water-insoluble film wrap. Each of these components will be described in more detail below.

Preferred compositions are cleaning compositions or fabric care compositions, preferably laundry or dish washing compositions. Typically, the composition herein comprises such an amount of a cleaning composition, that one or a multitude of the pouched compositions is or are sufficient for one wash.

The present system can comprise a tablet and a pouch packaged side-by-side in a film wrap or, preferably, a pouch on top of a tablet. To facilitate this the tablet can be pressed so that there is a depression on the top face where the pouch can sit.

The compositions herein can comprise a variety of ingredients. Some ingredients are preferentially added to the solid compositions and some are preferentially added to the liquid. Preferably, the both the compositions comprise at least one surfactant and at least one building agent.

Solid Composition

The present invention must comprise at least one solid detergent composition in the form of a tablet. Preferably the solid component comprises ingredients that are either difficult or costly to include in a substantially liquid composition or that are typically transported and supplied as solid ingredients which require additional processing steps to enable them to be included in a substantially liquid composition.

The solid composition is preferably prepared by mixing the solid ingredients together and compressing the mixture in a conventional tablet press as used, for example, in the pharmaceutical industry. The tablets are preferably compressed at a force of not more than 10000 N/cm², more preferably not more than 3000 N/cm², even more preferably not more than 750 N/cm². Suitable equipment includes a standard single stroke or a rotary press (such as is available form Courtoy®, Korsch®, Manesty® or Bonals®). Preferably the tablets are prepared by compression in a tablet press capable of preparing a tablet comprising a mould. Multi-phase tablets can be made using known techniques.

A preferred tabletting process comprises the steps of:

i) Lowering the core punch and feeding the core phase of the tablet into the resulting cavity,

ii) Lowering the whole punch and feeding the annular phase into the resulting cavity,

iii) Raising the core punch up to the annular punch level (this step can happen either during the annular phase feeding or during the compression step).

iv) Compressing both punches against the compression plate. A pre-compression step can be added to the compression phase. At the end of the process, both punches are at the same level.

v) The tablet is then ejected out of the die cavity by raising the punch system to the turret head level.

The solid compositions herein preferably have a diameter of between 20 mm and 60 mm, preferably of at least 35 mm and up to 55 mm, and a weight of between 25 and 100 grammes. The ratio of height to diameter (or width) of the tablets is preferably greater than 1:3, more preferably greater than 1:2. In a preferred embodiment according to the invention, the tablet has a density of at least 0.5 g/cc, more preferably at least 1.0 g/cc, and preferably less then 2.0 g/cc, more preferably less than 1.5 g/cc.

The solid composition preferably comprises at least one ingredient selected from builder, chelating agent, bleaching system, enzyme, optical brightener, suds suppressor, clay-softening system, disintegration aid(s), dyes, and mixtures thereof. More preferably the solid composition herein comprises at least one component selected from insoluble builder, bleaching system, disintegration aid(s), and mixtures thereof.

Builders

The compositions of the present invention can comprise builders. Suitable water-soluble builder compounds for use herein include water soluble monomeric polycarboxylates or their acid forms, homo- or co-polymeric polycarboxylic acids or their salts in which the polycarboxylic acid comprises at least two carboxylic radicals separated from each other by not more than two carbon atoms, carbonates, bicarbonates, borates, phosphates, and mixtures thereof.

The carboxylate or polycarboxylate builder can be monomeric or oligomeric in type although monomeric polycarboxylates are generally preferred. Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid as well as the ether carboxylates and the sulfinyl carboxylates. Polycarboxylates containing three carboxy groups include, in particular, water-soluble citrates, aconitrates and citraconates as well as succinate derivatives such as the carboxymethyloxysuccinates described in GB-A-1,379,241, lactoxysuccinates described in GB-A-1,389,732, amino-succinates described in NL-A-7205873, the oxypolycarboxylate materials described in GB-A-1,387,447. Polycarboxylates containing four carboxy groups suitable for use herein include those disclosed in GB-A-1,261,829. Polycarboxylates containing sulfo substituents include the sulfosuccinates derivatives disclosed in GB-A-1,398,421, GB-A-1,398,422 and U.S. Pat. No. 3,936,448 and the sulfonated pyrolysed citrates described in GB-A-1,439,000. Alicyclic and heterocyclic polycarboxylates include cyclopentane-cis,cis,cis-tetracarboxylates, 2,5-tetrahydrofuran-cis-dicarboxylates, 2,2,5,5-tetra-hydrofuran-tetracarboxylates, 1,2,3,4,5,6-hexane-hexacarboxylates and carboxymethyl derivatives of polyhydric alcohols such as sorbitol, mannitol and xylitol. Aromatic polycarboxylates include mellitic acid, pyromellitic acid and phthalic acid derivatives disclosed in GB-A-1,425,343. Preferred polycarboxylates are hydroxycarboxylates containing up to three carboxy groups per molecule, more particularly citrates. The parent acids of monomeric or oligomeric polycarboxylate chelating agents or mixtures thereof with their salts e.g. citric acid or citrate/citric acid mixtures are also contemplated as useful builders. Examples of carbonate builders are the alkaline earth and alkali metal carbonates, including sodium carbonate and sesqui-carbonate and mixtures thereof with ultra-fine calcium carbonate as disclosed in DE-A-2,321,001.

Suitable examples of phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerization ranges from about 6 to 21, and salts of phytic acid. A preferred phosphate builder is sodium tripolyphosphate.

Suitable partially water-soluble builder compounds for use herein include crystalline layered silicates as disclosed in EP-A-164,514 and EP-A-293,640. Preferred crystalline layered sodium silicates of general formula:

NaMSiₓO₂₊₁.yH₂O

wherein M is sodium or hydrogen, x is a number from 1.9 to 4 and y is a number from 0 to 20. Crystalline layered sodium silicates of this type preferably have a two dimensional sheet structure, such as the so called δ-layered structure as described in EP-A-164,514 and EP-A-293,640. Methods of preparation of crystalline layered silicates of this type are disclosed in DE-A-3,417,649 and DE-A-3,742,043. A more preferred crystalline layered sodium silicate compound has the formula δ-Na₂Si₂O₅, known as NaSKS-6™ available from Hoeschst AG.

Suitable largely water-insoluble builder compounds for use herein include the sodium aluminosilicates. Suitable aluminosilicates include the aluminosilicate zeolites having the unit cell formula Na_{z}[(AlO₂)_{z}(SiO₂)_{y}].xH2O wherein z and y are at least 6, the molar ratio of z to y is from 1 to 0.5 and x is at least 5, preferably from 7.5 to 276, more preferably from 10 to 264. The aluminosilicate material are in hydrated form and are preferably crystalline, containing from 10% to 28%, more preferably from 10% to 22% water in bound form. The aluminosilicate zeolites can be naturally occurring materials but are preferably synthetically derived. Synthetic crystalline aluminosilicate ion exchange materials are available under the designations Zeolite A, Zeolite B, Zeolite P, Zeolite X, and Zeolite HS. Preferred aluminosilicate zeolites are colloidal aluminosilicate zeolites. When employed as a component of a detergent composition colloidal aluminosilicate zeolites, especially colloidal zeolite A, provide ehanced builder performance, especially in terms of improved stain removal, reduced fabric encrustation and improved fabric whiteness maintenance. Mixtures of colloidal zeolite A and colloidal zeolite Y are also suitable herein providing excellent calcium ion and magnesium ion sequestration performance.

Chelating Agent

The solid compositions herein preferably comprise chelants/heavy metal ion sequestrants as the benefit agent. By heavy metal ion sequestrant it is meant herein components which act to sequester (chelate) heavy metal ions. These components may also have calcium and magnesium chelation capacity, but preferentially they show selectivity to binding heavy metal ions such as iron, manganese and copper.

Heavy metal ion sequestrants are generally present at a level of from 0.005% to 20%, preferably from 0.1% to 10%, more preferably from 0.25% to 7.5% and most preferably from 0.5% to 5% by weight of the compositions.

Heavy metal ion sequestrants, which are acidic in nature, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. Preferably any salts/complexes are water soluble. The molar ratio of said counter cation to the heavy metal ion sequestrant is preferably at least 1:1.

Suitable heavy metal ion sequestrants for use herein include organic phosphonates, such as the amino alkylene poly (alkylene phosphonates), alkali metal ethane 1-hydroxy disphosphonates and nitrilo trimethylene phosphonates. Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate.

Other suitable heavy metal ion sequestrant for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof.

Especially preferred is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt or complex thereof.

Enzymes

A preferred ingredient for the solid composition herein is one or more enzymes. Suitable enzymes include enzymes selected from peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, lipase.

Enzymes are generally incorporated in detergent compositions at a level of from 0.0001% to 2%, preferably from 0.001% to 0.2%, more preferably from 0.005% to 0.1% pure enzyme by weight of the composition.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimize their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application. In regard of enzyme stability in liquid detergents, attention should be focused on amino acids sensitive to oxidation in the case of bleach stability and on surface charges for the surfactant compatibility. The isoelectric point of such enzymes may be modified by the substitution of some charged amino acids. The stability of the enzymes may be further enhanced by the creation of e.g. additional salt bridges and enforcing metal binding sites to increase chelant stability. Furthermore, enzymes might be chemically or enzymatically modified, e.g. PEG-ylation, cross-linking and/or can be immobilized, i.e. enzymes attached to a carrier can be applied.

The enzyme to be incorporated in a detergent composition can be in any suitable form, e.g. liquid, encapsulate, prill, and/or granulate.

Optical Brightener

The compositions of the present invention can comprise optical brighteners. If present, shaped compositions herein preferably contain from 0.005% to 5% by weight of total composition of hydrophilic optical brighteners.

Hydrophilic optical brighteners useful herein include those having the structural formula:

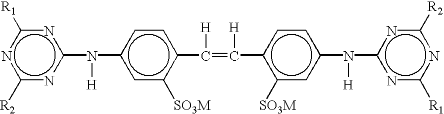

wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium.

When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopal-UNPA-GX by Ciba-Geigy Corporation. Tinopal-UNPA-GX is the preferred hydrophilic optical brightener useful in the detergent compositions herein.

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX by Ciba-Geigy Corporation.

When in the above formula, R₁ is anilino, R₂ is morphilino and M is a cation such as sodium, the brightener is 4,4′-bis[(4-anilino-6-morphilino-s-triazine-2-yl)amino]2,2′stilbenedisulfonic acid, sodium salt. This particular brightener species is commercially marketed under the tradename Tinopal AMS-GX by Ciba Geigy Corporation.

Other preferred optical brighteners are those known as Brightener 49 available from Ciba-Geigy.

Bleaching System

Another preferred ingredient for the solid composition herein is a bleaching system which preferably comprises a perhydrate bleach, such as salts of percarbonates, particularly the sodium salts, and/or organic peroxyacid bleach precursor, and/or transition metal bleach catalysts, especially those comprising Mn or Fe. It has been found that when the pouch or compartment is formed from a material with free hydroxy groups, such as PVA, the preferred bleaching agent comprises a percarbonate salt and is preferably free form any perborate salts or borate salts. It has been found that borates and perborates interact with these hydroxy-containing materials and reduce the dissolution of the materials and also result in reduced performance.

Inorganic perhydrate salts are a preferred source of peroxide. Examples of inorganic perhydrate salts include percarbonate, perphosphate, persulfate and persilicate salts. The inorganic perhydrate salts are normally the alkali metal salts. Alkali metal percarbonates, particularly sodium percarbonate are preferred perhydrates herein.

The bleaching system preferably comprises a peroxy acid or a precursor therefor (bleach activator), preferably comprising an organic peroxyacid bleach precursor. It may be preferred that the composition comprises at least two peroxy acid bleach precursors, preferably at least one hydrophobic peroxyacid bleach precursor and at least one hydrophilic peroxy acid bleach precursor, as defined herein. The production of the organic peroxyacid occurs then by an in-situ reaction of the precursor with a source of hydrogen peroxide. The hydrophobic peroxy acid bleach precursor preferably comprises a compound having a oxy-benzene sulphonate group, preferably NOBS, DOBS, LOBS and/or NACA-OBS, as described herein. The hydrophilic peroxy acid bleach precursor preferably comprises TAED.

Amide substituted alkyl peroxyacid precursor compounds can be used herein. Suitable amide substituted bleach activator compounds are described in EP-A-0170386.

The composition may contain a pre-formed organic peroxyacid. A preferred class of organic peroxyacid compounds are described in EP-A-170,386. Other organic peroxyacids include diacyl and tetraacylperoxides, especially diperoxydodecanedioc acid, diperoxytetradecanedioc acid and diperoxyhexadecanedioc acid. Mono- and diperazelaic acid, mono- and diperbrassylic acid and N-phthaloylaminoperoxicaproic acid are also suitable herein.

Suds Suppressing System

The compositions of the present invention can comprise a suds suppressing system present at a level of from 0.01% to 15%, preferably from 0.05% to 10%, most preferably from 0.1% to 5% by weight of the composition.

Suitable suds suppressing systems for use herein may comprise essentially any known antifoam compound, including, for example silicone antifoam compounds, 2-alkyl and alcanol antifoam compounds. Preferred suds suppressing systems and antifoam compounds are disclosed WO-A-93/08876 and EP-A-705 324.

Clay Softening System

The compositions of the present invention can comprise a clay softening system. Any suitable clay softening system may be used but preferred are those comprising a clay mineral compound and optionally a clay flocculating agent. If present, shaped compositions herein preferably contain from 0.001% to 10% by weight of total composition of clay softening system.

Preferred fabric softening clays are smectite clays, which can also be used to prepare the organophilic clays described hereinafter, for example as disclosed in U.S. Pat. Nos. 3,862,058, 3,948,790, 3,954,632, 4,062,647, EP-A-299575 and EP-A-313146. Specific examples of suitable smectite clays are selected from the classes of the bentonites—also known as montmorillonites, hectorites, volchonskoites, nontronites, saponites and sauconites, particularly those having an alkali or alkaline earth metal ion within the crystal lattice structure. Preferably, hectorites or montmorillonites or mixtures thereof. Hectorites are most preferred clays. Examples of hectorite clays suitable for the present compositions include Bentone EW as sold by Elementis.

Another preferred clay is an organophilic clay, preferably a smectite clay, whereby at least 30% or even at least 40% or preferably at least 50% or even at least 60% of the exchangeable cations is replaced by a, preferably long-chain, organic cations. Such clays are also referred to as hydrophobic clays. The cation exchange capacity of clays and the percentage of exchange of the cations with the long-chain organic cations can be measured in several ways known in the art, as for example fully set out in Grimshaw, The Chemistry and Physics of Clays, Interscience Publishers, Inc.,pp. 264-265 (1971). Highly preferred are organophilic clays as available from Rheox/Elementis, such as Bentone SD-1 and Bentone SD-3, which are registered trademarks of Rheox/Elementis.

Disintegration Aid

It is highly preferred that the solid compositions herein comprise a disintegration aid. As used herein, the term “disintegration aid” means a substance or mixture of substances that has the effect of hastening the dispersion of the matrix of the present compositions on contact with water. This can take the form of a substances which hastens the disintegration itself or substances which allow the composition to be formulated or processed in such a way that the disintegrative effect of the water itself is hastened. For example, suitable disintegration aid include clays that swell on contact with water (hence breaking up the matrix of the compositions) and coatings which increase tablet integrity allowing lower compression forces to be used during manufacture (hence the tablets are less dense and more easily dispersed.

Any suitable disintegration aid can be used but preferably they are selected from disintegrants, coatings, effervescents, binders, clays, highly soluble compounds, cohesive compounds, and mixtures thereof.

Disintegrant

The solid compositions herein can comprise a disintegrant that will swell on contact with water. Possible disintegrants for use herein include those described in the Handbook of Pharmaceutical Excipients (1986). Examples of suitable disintegrants include clays such as bentonite clay; starch: natural, modified or pregelatinised starch, sodium starch gluconate; gum: agar gum, guar gum, locust bean gum, karaya gum, pectin gum, tragacanth gum; croscarmylose sodium, crospovidone, cellulose, carboxymethyl cellulose, algenic acid and its salts including sodium alginate, silicone dioxide, polyvinylpyrrolidone, soy polysaccharides, ion exchange resins, and mixtures thereof.

Coating

Preferably the solid compositions of the present invention are coated. The coating can improve the mechanical characteristics of a shaped composition while maintaining or improving dissolution. This very advantageously applies to multi-layer tablets, whereby the mechanical constraints of processing the multiple phases can be mitigated though the use of the coating, thus improving mechanical integrity of the tablet. The preferred coatings and methods for use herein are described in EP-A-846,754, herein incorporated by reference.

As specified in EP-A-846,754, preferred coating ingredients are for example dicarboxylic acids. Particularly suitable dicarboxylic acids are selected from oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. Most preferred is adipic acid.

Preferably the coating comprises a disintegrant, as described hereinabove, that will swell on contact with water and break the coating into small pieces.

Effervescent

The solid compositions of the present invention preferably comprise an effervescent. As used herein, effervescency means the evolution of bubbles of gas from a liquid, as the result of a chemical reaction between a soluble acid source and an alkali metal carbonate, to produce carbon dioxide gas. The addition of this effervescent to the detergent improves the disintegration time of the compositions. The amount will preferably be from 0.1% to 20%, more preferably from 5% to 20% by weight of the tablet. Preferably the effervescent should be added as an agglomerate of the different particles or as a compact, and not as separate particles.

Further dispesion aid could be provided by using compounds such as sodium acetate, nitrilotriacetic acid and salts thereof or urea. A list of suitable dispersion aid may also be found in Pharmaceutical Dosage Forms: Tablets, Vol. 1, 2nd Edition, Edited by H. A. Lieberman et al, ISBN 0-8247-8044-2.

Binders

Non-gelling binding can be integrated to the particles forming the tablet in order to facilitate dispersion. If non-gelling binder are used they are preferably selected from synthetic organic polymers such as polyethylene glycols, polyvinylpyrrolidones, polyacetates, water-soluble acrylate copolymers, and mixtures thereof. The handbook of Pharmaceutical Excipients 2nd Edition has the following binder classification: Acacia, Alginic Acid, Carbomer, Carboxymethylcellulose sodium, Dextrin, Ethylcellulose, Gelatin, Guar Gum, Hydrogenated vegetable oil type I, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferred binder also have an active cleaning function in the wash such as cationic polymers. Examples include ethoxylated hexamethylene diamine quaternary compounds, bishexamethylene triamines or other such as pentaamines, ethoxylated polyethylene amines, maleic acrylic polymers.

Non-gelling binder materials are preferably sprayed on and hence preferably have a melting point of below 90° C., preferably below 70° C., more preferably below 50° C. so as not the damage or degrade the other active materials in the matrix. Most preferred are non-aqueous liquid binders (i.e. not in aqueous solution) which may be sprayed in molten form. However, they may also be solid binders incorporated into the matrix by dry addition but which have binding properties within the tablet.

Non-gelling binder materials are preferably used in an amount of from 0.1% to 15%, by weight of total composition.

Clays

The solid compositions herein may also comprise expandable clays. As used herein the term “expandable” means clays with the ability to swell (or expand) on contact with water. These are generally three-layer clays such as aluminosilicates and magnesium silicates having an ion exchange capacity of at least 50 meq/100 g of clay. The three-layer expandable clays used herein are classified geologically as smectites.

The clays useful for disintergration preferably have an ion-exchange capacity of at least 50 meq/100 g of clay. More preferably at least 60 meq/100 g of clay. The smectite clays used herein are all commercially available. For example, clay useful herein include montmorillonite, volchonskoite, nontronite, hectorite, saponite, sauconitem, vermiculite and mixtures thereof. The clays herein are available under various tradenames, for example, Thixogel #1 and Gelwhite GP from Georgia Kaolin Co., Elizabeth, N.J., USA; Volclay BC and Volclay #325 from American Colloid Co., Skokie, Ill., USA; Black Hills Bentonite BH450 from International Minerals and Chemicals; and Veegum Pro and Veegum F, from R. T. Vanderbilt. It is to be recognised that such smectite-type minerals obtained under the foregoing tradenames can comprise mixtures of the various discrete mineral entities. Such mixtures of the smectite minerals are suitable for use herein.

Highly Soluble Compounds

The compositions of the present invention may comprise a highly soluble compound. Such a compound could be formed from a mixture or from a single compound. Examples of preferred highly soluble compounds include salts of acetate, urea, citrate, phosphate, sodium diisobutylbenzene sulphonate (DIBS), sodium toluene sulphonate, and mixtures thereof.

Cohesive Compounds

The solid compositions herein may comprise a compound having a Cohesive Effect on the detergent matrix forming the composition. The Cohesive Effect on the particulate material of a detergent matrix forming the tablet or a layer of the tablet is characterised by the force required to break a tablet or layer based on the examined detergent matrix pressed under controlled compression conditions. For a given compression force, a high tablet or layer strength indicates that the granules stuck highly together when they were compressed, so that a strong cohesive effect is taking place. Means to assess tablet or layer strength (also refer to diametrical fracture stress) are given in Pharmaceutical dosage forms: tablets volume I Ed. H. A. Lieberman et al, published in 1989.

The cohesive effect is measured by comparing the tablet or layer strength of the original base powder without compound having a cohesive effect with the tablet or layer strength of a powder mix which comprises 97 parts of the original base powder and 3 parts of the compound having a cohesive effect. The compound having a cohesive effect is preferably added to the matrix in a form in which it is substantially free of water (water content below 10% (pref. below 5%)). The temperature of the addition is between 10 and 80° C., more pref. between 10 and 40° C.

A compound is defined as having a cohesive effect on the particulate material according to the invention when at a given compacting force of 3000N, tablets with a weight of 50 g of detergent particulate material and a diameter of 55 mm have their tablet tensile strength increased by over 30% (preferably 60 and more preferably 100%) by means of the presence of 3% of the compound having a cohesive effect in the base particulate material.

An example of a compound having a cohesive effect is sodium diisoalkylbenzene sulphonate.

Liquid/Gel Compositions

The present invention must comprise at least one liquid or gel detergent composition in a pouch. Preferably the liquid/gel component comprises ingredients that are either difficult or costly to include in a substantially solid composition or that are typically transported and supplied as liquid ingredients which require additional processing steps to enable them to be included in a substantially solid composition.

The pouches herein can be of any form which is suitable to hold the compositions, e.g. without allowing the substantial release of composition from the pouch prior to use. The exact execution will depend on, for example, the type and amount of the composition in the pouch, the number of compartments in the pouch, the characteristics required from the pouch to hold, protect and deliver or release the compositions.

Pouch Material

It is preferred that the pouch material used herein wholly comprises water-dispersible or more preferably water-soluble material. Preferred water-soluble films are polymeric materials, preferably polymers which are formed into a film or sheet. The material in the form of a film can for example be obtained by casting, blow-moulding, extrusion or blow extrusion of the polymer material, as known in the art. Preferred water-dispersible material herein has a dispersability of at least 50%, preferably at least 75% or even at least 95%, as measured by the method set out hereinafter using a glass-filter with a maximum pore size of 50 microns. More preferably the material is water-soluble and has a solubility of at least 50%, preferably at least 75% or even at least 95%, as measured by the method set out hereinafter using a glass-filter with a maximum pore size of 50 microns, namely:

Gravimetric method for determining water-solubility or water-dispersability of the material of the compartment and/or pouch:

5 grams±0.1 gram of material is added in a 400 ml beaker, whereof the weight has been determined, and 245 ml±1 ml of distilled water is added. This is stirred vigorously on a magnetic stirrer set at 600 rpm, for 30 minutes. If there are no visible lumps in the liquid, then the solution should be filtered as described below. If there are visible lumps remaining after this then the water should be heated to 70 deg C. and vigorous stirring continued for a further 20 minutes prior to filtering. Then, the mixture is filtered through a folded qualitative sintered-glass filter with the pore sizes as defined above (max. 50 micron). The water is dried off from the collected filtrate by any conventional method, and the weight of the remaining polymer is determined (which is the dissolved or dispersed fraction). Then, the percentage solubility or dispersability can be calculated.

The polymer can have any weight average molecular weight, preferably from about 1000 to 1,000,000, or even form 10,000 to 300,000 or even form 15,000 to 200,000 or even form 20,000 to 150,000.

Preferred film materials are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, polyvinyl alcohol copolymers and hydroxypropyl methyl cellulose (HPMC), and mixtures thereof. Most preferred are polyvinyl alcohols. Preferably, the level of a type polymer (e.g., commercial mixture) in the film material, for example PVA polymer, is at least 60% by weight of the film.

Mixtures of polymers can also be used. This may in particular be beneficial to control the mechanical and/or dissolution properties of the compartment or pouch, depending on the application thereof and the required needs. For example, it may be preferred that a mixture of polymers is present in the material of the compartment, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000-40,000, preferably around 20,000, and of PVA or copolymer thereof, with a weight average molecular weight of about 100,000 to 300,000, preferably around 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble. It may be preferred that the PVA present in the film is from 60-98% hydrolysed, preferably 80% to 90%, to improve the dissolution of the material.

Most preferred are films, which are water-soluble and stretchable films, as described above. Highly preferred water-soluble films are films which comprise PVA polymers and that have similar properties to the film known under the trade reference M8630, as sold by Chris-Craft Industrial Products of Gary, Ind., US and also PT-75, as sold by Aicello of Japan.

The water-soluble film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful that the pouch or water-soluble film itself comprises a detergent additive to be delivered to the wash water, for example organic polymeric soil release agents, dispersants, dye transfer inhibitors.

Composition

The pouches of the present invention can comprise a variety of liquid and/or gel compositions. The composition(s) preferably comprises less than 10%, preferably from 1% to 8%, more preferably from 2% to 7.5%, by weight, water. This is on basis of free water, added to the other ingredients of the composition.

The composition can made by any method and can have any viscosity, typically depending on its ingredients. The liquid/gel compositions preferably have a viscosity of 50 to 10000 cps (centipoises), as measured at a rate of 20 s⁻¹, more preferably from 300 to 3000 cps or even from 400 to 600 cps. The compositions herein can be Newtonian or non-Newtonian. The liquid composition preferably has a density of 0.8 kg/l to 1.3 kg/l, preferably around 1.0 to 1.1 kg/l.

In the compositions herein it is preferred that at least a surfactant and builder are present. Preferably the composition comprises 20-60% by weight of total liquid/gel composition (excluding the water-soluble film) of surfactant. Preferably the composition comprises at least anionic surfactant and nonionic surfactant. The composition preferably comprises 0.01%-30% by weight of total liquid/gel composition (excluding the water-soluble film) of fatty acid. The composition preferably comprises 0.01%-30% by weight of total liquid/gel composition (excluding the water-soluble film) of neutralizing agent such as sodium hydroxide.

Highly preferred for use in the liquid/gel compositions are solvents. Examples of suitable solvents are alcohols, diols, monoamine derivatives, glycerol, glycols, polyalkylane glycols, such as polyethylene glycol. Highly preferred are mixtures of solvents, such as mixtures of alcohols, mixtures of diols and alcohols, mixtures. Highly preferred may be that (at least) an alcohol, diol, monoamine derivative and preferably even glycerol are present. The compositions of the invention are preferably concentrated liquids having preferably less than 50% or even less than 40% by weight of solvent, preferably less than 30% or even less than 20% or even less than 35% by weight. Preferably the solvent is present at a level of at least 5% or even at least 10% or even at least 15% by weight of the composition.

Preferably the compositions herein comprise surfactant. Any suitable surfactant may be used. Preferred surfactants are selected from anionic, amphoteric, zwitterionic, nonionic (including semi-polar nonionic surfactants), cationic surfactants and mixtures thereof. The compositions preferably have a total surfactant level of from 0.5% to 75% by weight, more preferably from 1% to 50% by weight, most preferably from 5% to 30% by weight of total composition. Detergent surfactants are well known and described in the art (see, for example, “Surface Active Agents and Detergents”, Vol. I & II by Schwartz, Perry and Beach). Especially preferred are compositions comprising anionic surfactants. These can include salts (including, for example, sodium, potassium, ammonium, and substituted ammonium salts such as mono-, di- and triethanolamine salts) of the anionic sulfate, sulfonate, carboxylate and sarcosinate surfactants. Anionic sulfate surfactants are preferred. Other anionic surfactants include the isethionates such as the acyl isethionates, N-acyl taurates, fatty acid amides of methyl tauride, alkyl succinates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), N-acyl sarcosinates. Resin acids and hydrogenated resin acids are also suitable, such as rosin, hydrogenated rosin, and resin acids and hydrogenated resin acids present in or derived from tallow oil.

The composition can comprise a cyclic hydrotrope. Any suitable cyclic hydrotrope may be used. However, preferred hydrotropes are selected from salts of cumene sulphonate, xylene sulphonate, naphthalene sulphonate, p-toluene sulphonate, and mixtures thereof. Especially preferred are salts of cumene sulphonate. While the sodium form of the hydrotrope is preferred, the potassium, ammonium, alkanolammonium, and/or C₂-C₄ alkyl substituted ammonium forms can also be used.

The compositions herein may contain a C₅-C₂₀ polyol, preferably wherein at least two polar groups that are separated from each other by at least 5, preferably 6, carbon atoms. Particularly preferred C₅-C₂₀ polyols include 1,4 Cyclo Hexane Di Methanol, 1,6 Hexanediol, 1,7 Heptanediol, and mixtures thereof.

The compositions preferably comprise a water-soluble builder compound, typically present in detergent compositions at a level of from 1% to 60% by weight, preferably from 3% to 40% by weight, most preferably from 5% to 25% by weight of the composition.

Suitable water-soluble builder compounds include the water soluble monomeric carboxylates, or their acid forms, or homo or copolymeric polycarboxylic acids or their salts in which the polycarboxylic acid comprises at least two carboxylic radicals separated from each other by not more that two carbon atoms, and mixtures of any of the foregoing. Preferred builder compounds include citrate, tartrate, succinates, oxydissuccinates, carboxymethyloxysuccinate, nitrilotriacetate, and mixtures thereof.

Highly preferred may be that one or more fatty acids and/or optionally salts thereof (and then preferably sodium salts) are present in the detergent composition. It has been found that this can provide further improved softening and cleaning of the fabrics. Preferably, the compositions contain 1% to 25% by weight of a fatty acid or salt thereof, more preferably 6% to 18% or even 10% to 16% by weight. Preferred are in particular C₁₂-C₁₈ saturated and/or unsaturated, linear and/or branched, fatty acids, but preferably mixtures of such fatty acids. Highly preferred have been found mixtures of saturated and unsaturated fatty acids, for example preferred is a mixture of rape seed-derived fatty acid and C₁₆-C₁₈ topped whole cut fatty acids, or a mixture of rape seed-derived fatty acid and a tallow alcohol derived fatty acid, palmitic, oleic, fatty alkylsuccinic acids, and mixtures thereof.

The liquid/gel compositions herein may be a fabric softening component. Any suitable fabric softening component can be used. Examples of some suitable fabric softening components can be found in WO-A-99/40171 and include fabric softening clays, certain quaternary ammonium compounds, certain cellulases, and mixtures thereof. Preferred fabric softening agents for use in the liquid/gel composition herein are selected from quaternary ammonium agents. As used herein the term “quaternary ammonium agent” means a compound or mixture of compounds having a quaternary nitrogen atom and having one or more, preferably two, moieties containing six or more carbon atoms. Preferably the quaternary ammonium agents for use herein are selected from those having a quaternary nitrogen substituted with two moieties wherein each moiety comprises ten or more, preferably 12 or more, carbon atoms. In particular, diester and/or diamide quaternary ammonium (DEQA) compounds are preferred such as N,N-di(canolyl-oxy-ethyl)-N,N-dimethyl ammonium chloride, N,N-di(canolyl-oxy-ethyl)-N-methyl,N-(2-hydroxyethyl) ammonium methyl sulfate, N,N-di(canolyl-oxy-ethyl)-N-methyl, N-(2-hydroxyethyl) ammonium chloride and mixtures thereof.

Another preferred ingredient useful in the compositions herein is one or more enzymes. Suitable enzymes include enzymes selected from peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, lipase.

The compositions herein are preferably not formulated to have an unduly high pH. Preferably, the compositions of the present invention have a pH, measured as a 1% solution in distilled water, of from 7.0 to 12.5, more preferably from 7.5 to 11.8, most preferably from 8.0 to 11.5.

Additional Ingredients

In addition to the ingredients mentioned above the present compositions can comprise a variety of other ingredients. Ingredients suitable for inclusion into detergent compositions will readily suggest themselves to the skilled formulator.

Preferred additional ingredients include polymeric dye transfer inhibiting agents. Usually these agents are present at a level of from 0.01% to 10%, preferably from 0.05% to 0.5% by weight of composition. Examples of suitable polymeric dye transfer inhibiting agents are polyamine N-oxide polymers, copolymers of N-vinylpyrrolidone and N-vinylimidazole, polyvinylpyrrolidone polymers, or combinations thereof.

Another preferred additional ingredient is perfume. In the context of this specification, the term “perfume” means any odoriferous material or any material which acts as a malodour counteractant. In general, such materials are characterized by a vapour pressure greater than atmospheric pressure at ambient temperatures. The perfume or deodorant materials employed herein will most often be liquid at ambient temperatures, but also can be solids such as the various tamphoraceous perfumes known in the art. A wide variety of chemicals are known for perfumery uses, including materials such as aldehydes, ketones, esters and the like. More commonly, naturally occurring plant and animal oils and exudates comprising complex mixtures of various chemicals components are known for use as perfumes, and such materials can be used herein. The perfumes herein can be relatively simple in their composition or can comprise highly sophisticated, complex mixtures of natural and synthetic chemical components, all chosen to provide any desired odour.

The perfume component may comprise an encapsulate perfume, a properfume, neat perfume materials, and mixtures thereof.

Film Wrap

The solid and liquid compositions described hereinabove must be packaged in a water-insoluble film wrap. As used herein, the term “water-insoluble” means that the material does not substantially degrade upon contact with moisture. Any suitable film wrap may be used herein. Suitable films are described in Oswin, Plastic Films and Packaging, Applied Science Publishers Ltd., (1975). Preferably the films have a moisture vapour transfer rate (MVTR) of less than 20 g/m²/day, more preferably less than 10 g/m²/day. A description of MVTR and some suitable films can be found in EP-A-899,208.

Preferred materials for the film wrap are Biaxially Orientated Polypropylene films supplied by Mobil or 4P.

The film wrap may be applied to the solid and liquid/gel compositions in any suitable manner. For example, the horizontal form fill seal method may be used. For a discussion of this method see “The Packaging User's Handbook”, Edited by F. A. Paine, Second Edition, Ch. 9—‘Packaging with Flexible Barriers’, pp141-161.

Once the compositions are packaged in the film wrap they are preferably added to a secondary package before being shipped for sale. Such secondary packages are well-known in the art and are typically cartons. The film-wrapped compositions can be randomly packed in the secondary package or they can be arranged in an orderly manner.

Method of Cleaning

The present invention also relates to a method of cleaning in an automatic washing machine said method comprising adding at least one solid detergent composition in the form of a tablet and at least one liquid or gel filled water-soluble pouch composition to the machine and then cleansing in the normal manner.

The present method is particularly useful for the laundering of fabrics.

The method of the present invention provides the benefits having both a solid composition and a liquid/gel composition. Therefore, cleaning efficacy is improved and costs are keep down.

Preferred solid detergent compositions in the form of a tablet and liquid or gel filled water-soluble pouch compositions for use in this method are described hereinabove.

### EXAMPLES

### Example 1

Liquid Pouch Preparation

The ingredients below were mixed together to form a homogenous liquid.

| | Weight % |
|---|---|
| Nonionic surfactant | 15.2 |
| Anionic surfactant | 22.7 |
| Fatty Acid | 15.1 |
| Propandiol | 15.1 |
| MEA | 8.4 |
| Polycarboxylate polymer | 6.8 |
| Chelants | 2.0 |
| Perfume | 2.3 |
| Water/Misc | 12.4 |

25 ml of the above mixture was made. A water-soluble pouch was then prepared by the following method.

A vacuum of 500 mbar was used to draw a layer of 76 micron Monosol M-8630 PVA film into a 5 cm diameter, 25 cc, square mould containing 5 vacuum ports arranged at the bottom of the mould. The mould was partially filled with 25 mls of the liquid mix. A second layer of 76 micron Monosol M-8630 PVA film was then placed over the first film and heat sealed at 155° C. for 1.0 seconds and 2000 kN/m². The excess film trim was then removed leaving a frill of 3-5 mm around the pouch.

Tablet Preparation

A granular powder composition as described below was prepared into a tablet form.

| | Weight % |
|---|---|
| Cationic surfactant | 2.0 |
| Anionic surfactant | 5.0 |
| Citric Acid & Citrate | 1.0 |
| Sodium tripolyphosphate | 30.0 |
| Chelants | 1.0 |
| Layered silicate | 5.0 |
| Percarbonate | 18.0 |
| TAED | 6.0 |
| Enzymes | 1.8 |
| Sodium Carbonate | 22.0 |
| Silicone suds suppressor | 1.5 |
| PEG | 2.3 |
| Water/Misc | 4.3 |

The materials listed above were mixed together. Then 42 g of the mixture was introduced into a mould of square shape with a diameter of 4.5 cm and 3 cm depth, and compressed with a force of 5 kN, using a single stroke press to give tablets of about 2.2 cm height and a density of about 1.1 g./cc.

The tablet and pouch were then combined together by placing them in close proximity to each other on the guide track of a flow-wrapping machine. Suitable equipment is supplied by Sig.

The tablet and pouch were then wrapped together in one package using BOPP film (25 micron BBR film supplied by Poligal).

### Example 2

Liquid Pouch Preparation

The ingredients below were mixed together to form a homogenous liquid.

| | Weight % |
|---|---|
| Nonionic surfactant | 25.0 |
| Anionic surfactant | 25.0 |
| Fatty Acid | 14.0 |
| Propandiol | 14.0 |
| MEA | 9.0 |
| Polycarboxylate polymer | 6.0 |
| Perfume | 1.3 |
| Water/Misc | 6.0 |

25 ml of the above mixture was made. A water-soluble pouch was then prepared by the following method.

A vacuum of 500 mbar was used to draw a layer of 76 micron Monosol M-8630 PVA film into a 5 cm diameter, 25 cc, square mould containing 5 vacuum ports arranged at the bottom of the mould. The mould was partially filled with 25 mls of the liquid mix. A second layer of 76 micron Monosol M-8630 PVA film was then placed over the first film and heat sealed at 155° C. for 1.0 seconds and 2000 kN/m². The excess film trim was then removed leaving a frill of 3-5 mm around the pouch.

Tablet Preparation

A granular powder composition as described below was prepared into a tablet form.

| | Weight % |
|---|---|
| Cationic surfactant | 1.0 |
| Anionic surfactant | 9.7 |
| Citric Acid & Citrate | 2.3 |
| Zeolite | 19.0 |
| Chelants | 8.7 |
| Percarbonate | 20.8 |
| TAED | 7.4 |
| Enzymes | 1.8 |
| Sodium Carbonate | 23.0 |
| Silicone suds suppressor | 1.5 |
| PEG | 2.3 |
| Water/Misc | 2.3 |

The materials listed above were mixed together. Then 42 g of the mixture was introduced into a mould of square shape with a diameter of 4.5 cm and 3 cm depth, and compressed with a force of 1.5 kN or about 67 N/cm², using a single stroke press to give tablets of about 2.2 cm height and a density of about 1.1 g./cc.

Adipic acid was heated in a thermostatic bath till 170° C. with gentle stirring until molten. A disintegrant, Nymcel ZSB-16®, at a level of 5% by weight was then added with continuous stirring to the adipic acid to form a suspension. The tablets prepared as above were then dipped into the liquid to give the final coated tablet, this tablet had a total weight of 44.5 g,

The coated and pouch were then combined together by placing them in close proximity to each other on the guide track of a flow-wrapping machine. Suitable equipment is supplied by Sig. The tablet and pouch were then wrapped together in one package using BOPP film (25 micron BBR film supplied by Poligal).

### Example 3

2.5 Kg of mixed cottons were placed in a Miele automatic washing machine. The tablet and pouch of Example 1 were placed in a reticulated net which was then added to the drum of the washing machine. The fabrics were then washed at 40° C.

### Example 4

The coated tablet of Example 2 was placed in the dispensing draw of a Miele automatic washing machine. The pouch of Example 2 was placed in the drum of the same machine. 2.5 Kg of mixed cottons were then added to the drum of the washing machine. The fabrics were then washed at 40° C.

What is claimed is:

1. A detergent system comprising at least one solid detergent composition in the form of a tablet and at least one liquid or gel filled water-soluble pouch packaged together in a water-insoluble film wrap.

2. A detergent system according to claim 1 wherein both the solid and the liquid or gel compositions comprise at least one surfactant and at least one building agent.

3. A detergent system according to claim 1 wherein the solid composition is a compressed particulate.

4. A detergent system according to claim 3 wherein the solid composition comprises an ingredient selected from the group consisting of builders, chelating agents, bleaching systems, enzymes, optical brighteners, suds suppressors, clay-softening systems, disintegration aids, dyes, and mixtures thereof.

5. A detergent system according to claim 1 wherein the solid composition comprises an ingredient selected from the group consisting of insoluble builders, bleaching systems, disintegration aids, and mixtures thereof.

6. A detergent system according to claim 1 wherein the liquid or gel composition comprises from about 20 to about 60%, by weight of the total liquid/gel composition, of surfactant.

7. A detergent system according to claim 6 wherein the solid detergent composition comprises from 0.001% to 2%, by weight of the composition, of an enzyme.

8. A detergent system according to claim 7 wherein the solid detergent composition comprises from 0.005% to 5%, by weight of the composition, of hydrophilic optical brighteners.

9. A detergent system according to claim 1 wherein the solid composition is coated.

10. A detergent composition according to claim 9 wherein the solid composition is coated with a coating selected from the group consisting of oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof.

11. A detergent system according to claim 1 wherein the water soluble pouch comprises a film selected from the group consisting of polyacrylates, water-soluble acrylate polymers, methylcellulose, carboxymethylcellulose sodium dextrin, ethylcellulose, hydroxyethyl cellulose, hydroxypropyl methylcellulose, maltodextrin, polymethacrylates, polyvinyl alcohols, polyvinyl alcohol copolymers, hydroxyporpyl methyl cellulose, and mixtures thereof.

12. A detergent system according to claim 11 wherein the water-soluble pouch comprises a polyvinyl alcohol film.

13. A detergent system according to claim 1 wherein the film wrap is a biaxially orientated polypropylene film.

14. A detergent system according to claim 1 wherein the water-insoluble film wrap is selected from materials having a moisture vapor transfer rate of less than about 20 g/m²/day.

15. A detergent system comprising at least one solid detergent composition in the form of a tablet and at least one liquid or gel filled water-soluble pouch packaged together in a water-insoluble film wrap wherein:
a) the solid composition comprises an ingredient selected from the group consisting of builders, chelating agents, bleaching systems, enzymes, optical brighteners, suds suppressors, clay-softening systems, disintegration aids, dyes, and mixtures thereof;
b) the liquid or gel composition comprises a solvent selected from the group consisting of alcohols, diolos, monoamine derivatives, glycerol, glycols, polyalkylane glycols, and mixtures thereof.

16. A detergent system according to claim 15 wherein the water-insoluble film wrap is a biaxially orientated polypropylene film.

17. A detergent system according to claim 16 wherein the water-soluble pouch is a polyvinyl alcohol film.

18. A detergent system according to claim 15 wherein the the liquid or gel composition comprises from 20% to 60%, by weight of the liquid or gel composition, of surfactant.

19. A method of cleaning in an automatic washing machine said method comprising adding at least one solid detergent composition in the form of a tablet and at least one liquid or gel filled water-soluble pouch to the machine and then cleansing in the normal manner.

20. A method of laundering fabrics in an automatic washing machine said method comprising adding at least one solid detergent composition in the form of a tablet and at least one liquid or gel filled water-soluble pouch composition to the machine and then cleansing in the normal manner.
